(19) United States
(12) Patent Application Publication
(10) Pub. No.: US 2026/0172187 A1
(43) Pub. Date: Jun. 18, 2026

(54) DEMODULATION REFERENCE SIGNAL TIME DOMAIN ALLOCATION FOR FLUID START AND LENGTH INDICATOR VALUES

(71) Applicant: QUALCOMM Incorporated, San Diego, CA (US)

(72) Inventors: Somsubhra BARIK, San Diego, CA (US); Jing SUN, San Diego, CA (US); Chih-Hao LIU, San Diego, CA (US)

(21) Appl. No.: 18/982,871

(22) Filed: Dec. 16, 2024

(51) Int. Cl. H04L 5/00

(52) U.S. Cl. CPC H04L 5/0051

(57) ABSTRACT

Methods, systems, and devices for wireless communications are described. A network entity may perform a shared channel communication in accordance with a fluid start and length indicator value (SLIV) based on positions and quantities of demodulation reference signal (DMRS) symbols defined according to one or more control messages. The network entity may receive an indication of DMRS parameters, where the DMRS parameters include one or more DMRS offsets and a DMRS spacing. The network entity may receive scheduling information for a shared channel communication, where the scheduling information indicates a starting slot, a starting symbol within the starting slot, and a quantity of DMRS instances, where a time domain length of the shared channel communication is based on the one or more DMRS offsets, the DMRS spacing, and the quantity of DMRS instances. The network entity may perform the shared channel communication in accordance with the scheduling information.

### INTRODUCTION

The following relates to wireless communications, including demodulation reference signal time domain allocation for fluid start and length indicator values.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communications by a network entity is described. The method may include receiving an indication of a set of demodulation reference signal (DMRS) parameters, where the set of DMRS parameters is indicative of one or more DMRS offsets and a DMRS spacing, receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and performing the shared channel communication in accordance with the scheduling information.

A network entity for wireless communications is described. The network entity may include a processing system configured to receive an indication of a set of DMRS parameters, where the set of DMRS parameters is indicative of one or more DMRS offsets and a DMRS spacing, receive scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and perform the shared channel communication in accordance with the scheduling information.

Another network entity for wireless communications is described. The network entity may include means for receiving an indication of a set of DMRS parameters, where the set of DMRS parameters is indicative of one or more DMRS offsets and a DMRS spacing, means for receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and means for performing the shared channel communication in accordance with the scheduling information.

A non-transitory computer-readable medium having code for wireless communications stored thereon is described. The code, when executed by a network entity, may cause the network entity to receive an indication of a set of DMRS parameters, where the set of DMRS parameters is indicative of one or more DMRS offsets and a DMRS spacing, receive scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and perform the shared channel communication in accordance with the scheduling information.

In some examples of the method, network entities, and non-transitory computer-readable medium described herein, a first DMRS offset of the one or more DMRS offsets may be from a first data symbol, in time, of one or more data symbols of the shared channel communication and a first DMRS symbol, in time, of the quantity of DMRS instances of the shared channel communication, a second DMRS offset of the one or more DMRS offsets may be from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

In some examples of the method, network entities, and non-transitory computer-readable medium described herein, the set of DMRS parameters further includes a DMRS threshold parameter, the DMRS threshold parameter indicative of a threshold quantity of DMRS symbols per DMRS instance of the quantity of DMRS instances and the time domain length of the shared channel communication may be based on the threshold quantity of DMRS symbols per DMRS instance.

In some examples of the method, network entities, and non-transitory computer-readable medium described herein, at least one of the set of DMRS parameters or the scheduling information may be based on a connectivity state of the network entity, the connectivity state may be associated a set of allowed shared channel communication time domain lengths, and the set of allowed shared channel communication time domain lengths includes the time domain length of the shared channel communication.

In some examples of the method, network entities, and non-transitory computer-readable medium described herein, the connectivity state includes one of an initial access state with respect to a second network entity, a radio resource control (RRC) inactive state with respect to the second network entity, an RRC idle state with respect to the second network entity, an RRC connected state prior to capability reporting, or an RRC connected state after receipt of a configuration message.

In some examples of the method, network entities, and non-transitory computer-readable medium described herein, the connectivity state may be the initial access state, the RRC idle state, the RRC inactive state, or the RRC connected state prior to capability reporting and the method, apparatuses, and non-transitory computer-readable medium may include further operations, features, means, or instructions for receiving an indication of allowed sets of DMRS parameters in association with the connectivity state, the allowed sets of DMRS parameters including the set of DMRS parameters and receiving an indication of allowed sets of combinations of starting slots, starting symbols within starting slots, and quantities of DMRS instances for shared channel communications, where the scheduling information indicates an allowed combination from the allowed sets of combinations.

In some examples of the method, network entities, and non-transitory computer-readable medium described herein, receiving the indication of the allowed sets of DMRS parameters and the indication of the allowed sets of combinations may include operations, features, means, or instructions for receiving a broadcast message that includes the indication of the allowed sets of DMRS parameters and the indication of the allowed sets of combinations.

In some examples of the method, network entities, and non-transitory computer-readable medium described herein, receiving the indication of the allowed sets of DMRS parameters and the indication of the allowed sets of combinations may include operations, features, means, or instructions for receiving, from memory of the network entity, the indication of the allowed sets of DMRS parameters and the indication of the allowed sets of combinations based on the connectivity state.

Some examples of the method, network entities, and non-transitory computer-readable medium described herein may further include operations, features, means, or instructions for transmitting a capability report that indicates a capability of the network entity for communication of shared channel transmissions, where, to receive the indication of the set of DMRS parameters, the method includes receiving a control message that includes the indication of the set of DMRS parameters in accordance with the capability of the network entity.

In some examples of the method, network entities, and non-transitory computer-readable medium described herein, the scheduling information may be in accordance with the capability of the network entity.

In some examples of the method, network entities, and non-transitory computer-readable medium described herein, the capability report indicates a DMRS processing capability of the network entity and the set of DMRS parameters may be in accordance with the DMRS processing capability.

In some examples of the method, network entities, and non-transitory computer-readable medium described herein, the capability report indicates a threshold transport block size capability associated with the network entity and the quantity of DMRS instances may be based on the threshold transport block size capability.

In some examples of the method, network entities, and non-transitory computer-readable medium described herein, receiving the scheduling information may include operations, features, means, or instructions for receiving a control message that indicates one or more rows in a time domain resource allocation (TDRA) table, where the one or more rows in the TDRA table indicate the starting slot, the starting symbol, and the quantity of DMRS instances.

In some examples of the method, network entities, and non-transitory computer-readable medium described herein, the indication of the set of DMRS parameters may be received via an RRC message and the scheduling information may be received via a downlink control information (DCI) message.

A method of wireless communications by a first network entity is described. The method may include outputting or obtaining an indication of a set of DMRS parameters for a second network entity, where the set of DMRS parameters is indicative of one or more DMRS offsets and a DMRS spacing, outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and perform the shared channel communication with the second network entity in accordance with the scheduling information.

A first network entity for wireless communications is described. The first network entity may include a processing system configured to output or obtain an indication of a set of DMRS parameters for a second network entity, where the set of DMRS parameters is indicative of one or more DMRS offsets and a DMRS spacing, output, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and perform the shared channel communication with the second network entity in accordance with the scheduling information.

Another first network entity for wireless communications is described. The first network entity may include means for outputting or obtaining an indication of a set of DMRS parameters for a second network entity, where the set of DMRS parameters is indicative of one or more DMRS offsets and a DMRS spacing, means for outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and means for perform the shared channel communication with the second network entity in accordance with the scheduling information.

A non-transitory computer-readable medium having code for wireless communications stored thereon is described. The code, when executed by a network entity, may cause the network entity to output or obtain an indication of a set of DMRS parameters for a second network entity, where the set of DMRS parameters is indicative of one or more DMRS offsets and a DMRS spacing, output, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances, and perform the shared channel communication with the second network entity in accordance with the scheduling information.

In some examples of the method, first network entities, and non-transitory computer-readable medium described herein, a first DMRS offset of the one or more DMRS offsets may be from a first data symbol, in time, of one or more data symbols of the shared channel communication and a first DMRS symbol, in time, of the quantity of DMRS instances of the shared channel communication, a second DMRS offset of the one or more DMRS offsets may be from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

In some examples of the method, first network entities, and non-transitory computer-readable medium described herein, the set of DMRS parameters further includes a DMRS threshold parameter, the DMRS threshold parameter indicative of a threshold quantity of DMRS symbols per DMRS instance of the quantity of DMRS instances and the time domain length of the shared channel communication may be based on the threshold quantity of DMRS symbols per DMRS instance.

In some examples of the method, first network entities, and non-transitory computer-readable medium described herein, at least one of the set of DMRS parameters or the scheduling information may be based on a connectivity state of the second network entity, the connectivity state may be associated a set of allowed shared channel communication time domain lengths, and the set of allowed shared channel communication time domain lengths includes the time domain length of the shared channel communication.

In some examples of the method, first network entities, and non-transitory computer-readable medium described herein, the connectivity state includes one of an initial access state with respect to the first network entity, an RRC inactive state with respect to the first network entity, an RRC idle state with respect to the first network entity, an RRC connected state prior to capability reporting, or an RRC connected state after receipt of a configuration message.

In some examples of the method, first network entities, and non-transitory computer-readable medium described herein, the connectivity state may be the initial access state and the method, apparatuses, and non-transitory computer-readable medium may include further operations, features, means, or instructions for outputting or obtaining an indication of allowed sets of DMRS parameters in association with the connectivity state, the allowed sets of DMRS parameters including the set of DMRS parameters and outputting or obtaining an indication of allowed sets of combinations of starting slots, starting symbols within starting slots, and quantities of DMRS instances for shared channel communications, where the scheduling information indicates an allowed combination from the allowed sets of combinations.

In some examples of the method, first network entities, and non-transitory computer-readable medium described herein, outputting or obtaining the indication of the allowed sets of DMRS parameters and the indication of the allowed sets of combinations may include operations, features, means, or instructions for outputting a broadcast message that includes the indication of the allowed sets of DMRS parameters and the indication of the allowed sets of combinations.

In some examples of the method, first network entities, and non-transitory computer-readable medium described herein, outputting or obtaining the indication of the allowed sets of DMRS parameters and the indication of the allowed sets of combinations may include operations, features, means, or instructions for obtaining, from memory of the first network entity, the indication of the allowed sets of DMRS parameters and the indication of the allowed sets of combinations based on the connectivity state.

Some examples of the method, first network entities, and non-transitory computer-readable medium described herein may further include operations, features, means, or instructions for obtaining a capability report that indicates a capability of the second network entity for communication of shared channel transmissions where, to output or obtain the indication of the set of DMRS parameters, the method includes outputting a control message that includes the indication of the set of DMRS parameters in accordance with the capability of the second network entity.

In some examples of the method, first network entities, and non-transitory computer-readable medium described herein, the scheduling information may be in accordance with the capability of the second network entity.

In some examples of the method, first network entities, and non-transitory computer-readable medium described herein, the capability report indicates a DMRS processing capability of the second network entity and the set of DMRS parameters may be in accordance with the DMRS processing capability.

In some examples of the method, first network entities, and non-transitory computer-readable medium described herein, the capability report indicates a threshold transport block size capability associated with the second network entity and the quantity of DMRS instances may be based on the threshold transport block size capability.

In some examples of the method, first network entities, and non-transitory computer-readable medium described herein, outputting the scheduling information may include operations, features, means, or instructions for outputting a control message that indicates one or more rows in a time domain resource allocation (TDRA) table, where the one or more rows in the TDRA table indicate the starting slot, the starting symbol, and the quantity of DMRS instances.

In some examples of the method, first network entities, and non-transitory computer-readable medium described herein, the indication of the set of DMRS parameters may be output via an RRC message and the scheduling information may be output via a DCI message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communication systems that support demodulation reference signal (DMRS) time domain allocation for fluid start and length indicator values (SLIVs) in accordance with one or more aspects of the present disclosure.

FIG. 3 shows an example of a process flow that supports DMRS time domain allocation for fluid SLIVs in accordance with one or more aspects of the present disclosure.

FIGS. 4 and 5 show block diagrams of devices that support DMRS time domain allocation for fluid SLIVs in accordance with one or more aspects of the present disclosure.

FIG. 6 shows a block diagram of a communications manager that supports DMRS time domain allocation for fluid SLIVs in accordance with one or more aspects of the present disclosure.

FIG. 7 shows a diagram of a system including a device that supports DMRS time domain allocation for fluid SLIVs in accordance with one or more aspects of the present disclosure.

FIGS. 8 and 9 show block diagrams of devices that support DMRS time domain allocation for fluid SLIVs in accordance with one or more aspects of the present disclosure.

FIG. 10 shows a block diagram of a communications manager that supports DMRS time domain allocation for fluid SLIVs in accordance with one or more aspects of the present disclosure.

FIG. 11 shows a diagram of a system including a device that supports DMRS time domain allocation for fluid SLIVs in accordance with one or more aspects of the present disclosure.

FIGS. 12 through 15 show flowcharts illustrating methods that support DMRS time domain allocation for fluid SLIVs in accordance with one or more aspects of the present disclosure.

### DETAILED DESCRIPTION

Wireless communication devices may communicate over resources in a time domain according to start and length indicator values (SLIVs). In some cases, SLIVs may indicate a length of up to a threshold quantity of symbols (e.g., 14 symbols). For example, downlink control information (DCI) that schedules a shared channel communication (such as a physical uplink shared channel (PUSCH) communication or a physical downlink shared channel (PDSCH) communication) may indicate the SLIV by indicating the starting slot, the starting symbol within the starting slot, and the length of the shared channel communication in quantity of symbols. In such cases, the SLIVs may accommodate or correspond to slot boundaries occurring at symbol intervals of the threshold quantity of symbols. Additionally, the wireless communications devices may communicate demodulation reference signals (DMRS) within a shared channel communication, where DMRS instances may be scheduled within the time period corresponding to a SLIV. For example, positions of DMRSs within the SLIV may be defined in a table according to one or more parameters, such as starting or ending offsets for DMRS instances with respect to the starting and ending symbol of a shared channel communication and a quantity of the DMRS instances. However, some SLIVs, which may be referred to as fluid SLIVs, may have slot boundaries that do not occur at the symbol intervals of the threshold quantity of symbols (e.g., 14-symbol intervals). In cases in which the SLIVs have slot boundaries that do not occur at the symbol intervals, the table may not account for or define positions of DMRSs.

In some aspects, wireless communications devices may perform a shared channel communication over a length of time that is based on a quantity of DMRSs within the shared channel communication. For example, a first control message, such as a radio resource control (RRC) message, may indicate DMRS parameters for shared channel communications including the starting and ending DMRS offsets and the DMRS spacing. Alternatively, the starting and ending DMRS offsets and the DMRS spacing may be stored in a memory of a wireless communications device or may be signaled via a broadcast message. A second control message, such as a DCI message, may schedule a shared channel communication via indicating the starting slot and symbol within the starting slot for the shared channel communication and via indicating the quantity of DMRS instances for the shared channel communication. The wireless communications devices may perform the scheduled shared channel communication over a length of time that is defined based on the starting and ending DMRS offsets, the DMRS spacing, and the quantity of DMRS instances indicated by the DMRS parameters (e.g., that may be signaled in the first control message or stored in memory) and the second control message. In some aspects, the DMRS parameters may correspond to a connectivity state of a wireless communications device, such as a user equipment (UE). Additionally, or alternatively, parameters associated with scheduling the shared channel may be based on the connectivity state of the wireless communications device.

Aspects of the disclosure are initially described in the context of wireless communication systems. Aspects of the disclosure are further described in the context of process flows. Aspects of the disclosure are further illustrated by and described with reference to apparatus diagrams, system diagrams, and flowcharts that relate to DMRS time domain allocation for fluid SLIVs.

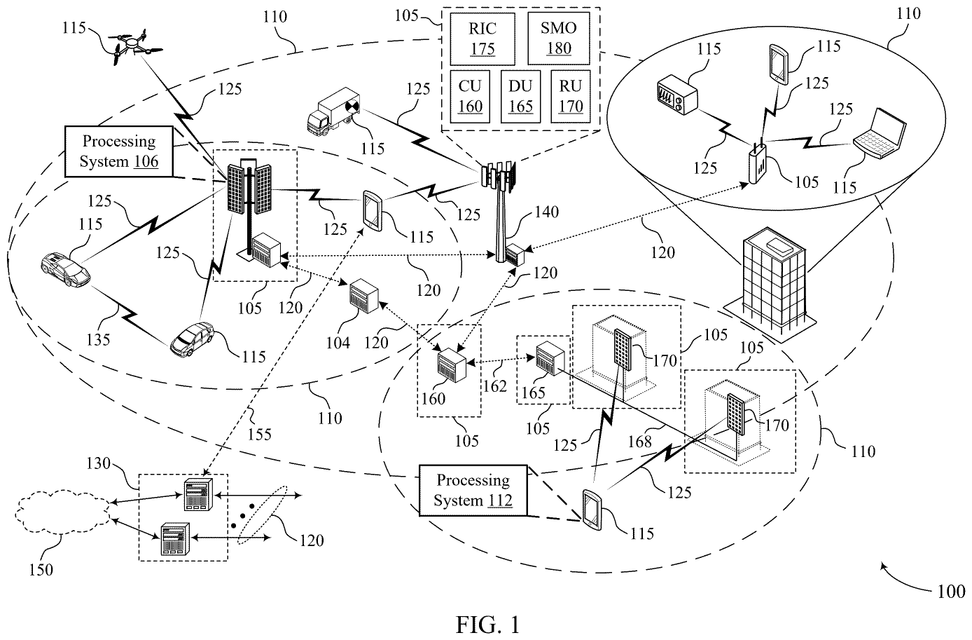

FIG. 1 shows an example of a wireless communication system 100 that supports DMRS time domain allocation for fluid SLIVs in accordance with one or more aspects of the present disclosure. The wireless communication system 100 may include one or more devices, such as one or more network devices (e.g., network entities 105), one or more UEs 115, and a core network 130. In some aspects, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the wireless communication system 100. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some aspects, the first communication interface may be an interface configured to receive input information, and the information may be provided to the processing system. In some aspects, the second system interface may be configured to transmit information output from the chip or modem. The second communication interface may also obtain or receive input information, and the first communication interface may also output, transmit, or provide information.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support DMRS time domain allocation for fluid SLIVs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some aspects, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the network entity 105 may perform repeated transmissions with multiple segments of consecutive (e.g., back-to-back) symbols, such as in accordance with extending a cell boundary coverage of a cell supported by the network entity 105. Alternatively, the network entity 105 may extend the cell boundary coverage via fluid SLIVs. For example, some communication applications may demand a more generic definition of SLIV length, where, based on packet load from upper layers and traffic flow patterns, the physical layer scheduler may not be restricted to scheduling data over fixed quantities of symbols (e.g., 14 symbols). Fluid SLIVs may support scheduling data over different quantities of symbols (e.g., other than 14 symbols). Fluid SLIVs may have arbitrary symbol lengths that may be different than a length of another SLIV. For example, some SLIVs may have a threshold quantity of symbols (e.g., 14 symbols) that corresponds to a quantity of symbols in a slot. In other words, some SLIVs may not exceed slot boundaries. In some aspects, fluid SLIVs may exceed slot boundaries. For example, fluid SLIVs may exceed the threshold quantity of symbols that corresponds to the quantity of symbols in a slot (e.g., exceed 14 symbols).

Accordingly, the network entity 105 may perform a transmission in accordance with a fluid SLIV that may extend past one or more slot boundaries, such as alternatively to performing repeated transmissions over different slots in accordance with fixed SLIVs per slot. Transmission in accordance with the fluid SLIV may be associated with improved resource utilization based on a reduction in resource overhead. For example, the network entity 105 may perform the transmission across multiple slots based on a single control message (e.g., a single DCI) for the multiple slots (e.g., as compared to one DCI per slot or per SLIV). Additionally, or alternatively, the fluid SLIV may support reduced complexity at the network entity 105, the UE 115 (e.g., in communication with the network entity 105, receiving the transmission), or both. For example, the fluid SLIV may not involve multi-segment coordination in a time domain.

However, one or more communications parameters that are defined (e.g., in a table, in memory of devices, etc.) in accordance with the threshold quantity of symbols corresponding to the quantity of symbols in the slot may not be applicable to fluid SLIVs. As an example, pilot symbol spacing may be defined based on 14-symbol SLIVs and, accordingly, may not be applicable to soft TTI values associated with fluid SLIVs. Additionally, quantities of DMRS instances may be defined for quantities of scheduled symbols (e.g., lengths of SLIVs) up to the threshold quantity of symbols, but not for other possible lengths of fluid SLIVs (e.g., greater than 14 symbols). For example, given a quantity of scheduled symbols (e.g., scheduled via a DCI), a quantity of DMRS instances in a SLIV and a quantity of symbols beyond a last DMRS instance may be defined based on a DMRS separation and a starting DMRS offset. However, the DMRS positions may not be defined for fluid SLIV lengths exceeding the threshold quantity of symbols.

Accordingly, aspects of this disclosure involve techniques for assigning DMRS time indices to resource allocations of arbitrary lengths. For example, SLIV lengths may be characterized in terms of DMRS spacings and offsets to define sets of SLIV lengths a UE 115 may demand to support at different stages of network connectivity. To support communications in accordance with fluid SLIVs, network entities described herein may communicate control messages including DMRS parameters and scheduling information that may be used to determine positions of DMRSs within fluid SLIVs. For example, the network entity 105 may schedule a shared channel communication with the UE 115 via a control message (e.g., DCI) that indicates a slot offset, a starting symbol, and a quantity of DMRS instances. A length of the shared channel communication (e.g., a fluid SLIV length) may be based on the slot offset, the starting symbol, and the quantity of DMRS instances in addition to DMRS parameters including DMRS offsets and a DMRS spacing, where the DMRS parameters may be predefined (e.g., in a table stored at a memory of the network entity 105, the UE 115, or both), signaled, or a combination thereof. For example, the network entity 105, the UE 115, or both may determine the length of the shared channel communication based on the control message and the DMRS parameters. By including information that may be used to determine the fluid SLIV length in control messages, at memories of wireless communications devices, or both, techniques described herein support efficient shared channel communication scheduling involving fluid SLIVs.

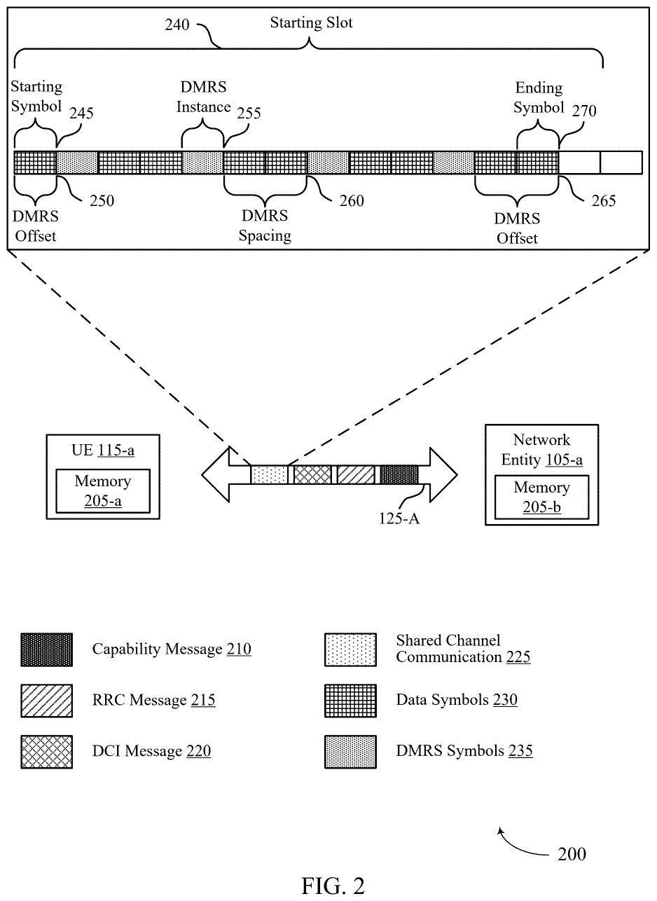

FIG. 2 shows an example of a wireless communication system 200 that supports DMRS time domain allocation for fluid SLIVs in accordance with one or more aspects of the present disclosure. Aspects of the wireless communication system 200 may implement, or be implemented by, aspects of the wireless communication system 100 as described herein with reference to FIG. 1. For example, the wireless communication system 200 may include a UE 115-a and a network entity 105-a, which may be examples of the UE 115 and the network entity 105, respectively, as described with reference to FIG. 1. The UE 115-a and the network entity 105-a may communicate using a communication link 125-a, which may be an example of a communication link 125 as described herein.

The UE 115-a and the network entity 105-a may exchange one or more messages in association with a shared channel communication 225. For example, the UE 115-a and the network entity 105-a may exchange the one or more messages that indicate DMRS parameters and scheduling information associated with the shared channel communication 225, where the UE 115-a and the network entity 105-a perform the shared channel communication 225 in accordance with the DMRS parameters and scheduling information. In some aspects, performing the shared channel communication 225 in accordance with the DMRS parameters and the scheduling information may involve performing the shared channel communication over a symbol length (e.g., a fluid SLIV) that is based on the DMRS parameters and the scheduling information.

The UE 115-a may obtain an indication of the DMRS parameters, including a starting DMRS offset 250, an ending DMRS offset 265, and a DMRS spacing 260. In some aspects, the starting DMRS offset 250 (e.g., “A”) may refer to an offset (e.g., in symbols) between a starting symbol 245 of data symbols 230 in a SLIV and a first DMRS symbol of DMRS symbols 235 in the SLIV. The first data symbol and the first DMRS symbol may be “first” in time relative to other data or DMRS symbols in the SLIV. Additionally, the ending DMRS offset 265 (e.g., “B”) may refer to an offset (e.g., in symbols) between a last data symbol 270 of data symbols 230 in the SLIV and the last DMRS symbol of DMRS symbols 235 in the SLIV. The last data symbol and the last DMRS symbol may be “last” in time relative to the other data or DMRS symbols in the SLIV. The DMRS spacing 260 (e.g., “S”) may refer to a quantity of symbols between successive (e.g., consecutive, adjacent, etc. in time) DMRS instances. In some aspects, the DMRS spacing 260 may be uniform and refer to a single quantity of symbols between successive DMRS instances. In some other aspects, the DMRS spacing 260 may be non-uniform and refer to a set of spacings or multiple different spacings between successive DMRS instances. As used herein, an “instance” may refer to one or more symbols in which a DMRS occurs, where each DMRS instance 255 is separated from other DMRS instances by at least one data symbol. Additionally, the DMRS parameters may include a threshold DMRS length (e.g., “x”). The threshold DMRS length may refer to a threshold quantity of DMRS symbols per DMRS instance.

In some aspects, the UE 115-a may obtain the indication of the DMRS parameters via an RRC message 215. For example, the network entity 105-a may output the RRC message 215 to the UE 115-a, where the RRC message 215 includes the indication of the DMRS parameters. In such examples, the DMRS parameters may be included in an RRC configuration and referred to as RRC parameters.

The UE 115-a may obtain the scheduling information including a slot offset, starting symbol 245, and a quantity of DMRS instances. The scheduling information may indicate the starting slot 240 of the SLIV via a slot offset K₀. For example, the slot offset K₀ may correspond to a quantity of slots between a DCI message 220 and the shared channel communication 225 that is scheduled by the DCI message 220. In other words, the scheduling information may indirectly indicate the starting slot 240 by indicating the slot offset K₀, where the starting slot 240 is in accordance with the slot offset K₀. In some aspects, K₀ may be “0” (e.g., same-slot scheduling may be supported). In some aspects, the scheduling information may indicate the starting symbol 245 (e.g., L₀), which may refer to a symbol within the starting slot 240 where the shared channel communication 225 begins. In other words, the starting symbol 245 refers to a first symbol in time of the shared channel communication 225. The quantity of DMRS instances may refer to how many times a DMRS is communicated in the shared channel communication 225. In some aspects, the quantity of DMRS instances may refer to a quantity of symbols in which the DMRS is communicated in the SLIV.

The network entity 105-a may indicate a time domain resource allocation to the UE 115-a via the DMRS parameters and the scheduling information, based on which the UE 115-a may determine a shared channel communication 225 symbol bitmap on a per-grant basis. For example, the starting DMRS offset 250, the ending DMRS offset 265, and the DMRS spacing 260, in combination with the quantity of DMRS instances, may define positions or locations of DMRS instances within the shared channel communication 225. The UE 115-a, the network entity 105-a, or both may determine the positions of the DMRS symbols 235 based on the DMRS parameters and the scheduling information. Additionally, a length of the shared channel communication 225 (e.g., a length of the SLIV) may be based on the DMRS parameters and the scheduling information. For example, a time domain resource length (e.g., a quantity of symbols “T”) of the shared channel communication 225 may be defined according to the starting DMRS offset 250 (“A”), the ending DMRS offset 265 (“B”), the DMRS spacing 260 (“S”), the threshold DMRS length (“x”), and the quantity of DMRS instances (“M”) as defined in Equation 1 below.

$$T = A + B + ( M - 1 ) * S + M * x \qquad ( 1 )$$

By indicating the time domain resource allocation to the UE 115-a via the DMRS parameters and the scheduling information, the UE 115-a and the network entity 105-a may support reduced signaling overhead and flexibility of scheduling shared channel communications with arbitrary durations (e.g., durations not corresponding to slot boundaries, such as fluid SLIVs). Indicating the time domain resource allocation via the DMRS parameters and the scheduling information may reduce signaling overhead compared to indicating DMRS symbol locations explicitly via RRC and indicating a quantity of scheduled shared channel communications symbols (e.g., PUSCH or PDSCH) via DCI. Techniques described herein may involve adjusting the RRC message to include an indication of the DMRS spacing 260, the starting DMRS offset 250, the ending DMRS offset 265, and/or the maximum DMRS length (maxlength(x)) (e.g., as compared to explicitly indicating DMRS symbol locations such as via RRC signaling). Additionally, techniques described herein may involve adjusting the DCI message to include an explicit indication of DMRS instances M (e.g., rather than a quantity of shared channel communications symbols). Thus, described techniques may allow for DMRS spacing and offset based configuration via RRC and indication via DCI of the quantity of DMRS instances for a given shared channel communication. In some aspects, the time domain resource allocation may be in accordance with a connectivity status of the UE 115-a.

The UE 115-a may process fluid SLIVs of lengths that are scheduled by the network entity 105-a throughout interactions with a cell of the network entity 105-a (e.g., supported by the network entity 105-a). For example, the UE 115-a may process fluid SLIVs when in different connectivity states or stages. Connectivity states of the UE 115-a may include an initial access stage or an RRC idle stage prior to RRC attachment, an RRC connected mode prior to capability reporting, an RRC inactive state, or an RRC connected mode after RRC reconfiguration based on UE capability reporting.

In some aspects, a set of time domain resources that the UE 115-a supports may be based on a connectivity state, nature of the shared channel communication 225, or both. For example, the UE 115-a may be expected to support standard-mandated or network-specified sets of SLIV lengths at different stages of RRC connectivity. As an example, paging messages or random access response (RAR) messages on a PDSCH using a paging radio network temporary identifier (P-RNTI) or a random access RNTI (RA-RNTI), respectively, and using a first DCI format (e.g., DCI 1_0) may involve lower transport block sizes (e.g., lower transport block size (TBS) values, such as compared to other messages). In such examples, a shared channel communication including paging messages or RAR messages may include fewer DMRS instances in a TTI (e.g., in a fluid SLIV), such as relative to a communication scheduled by a different DCI format (e.g., DCI format 1_1). Accordingly, fixed or allowed sets of combinations of DMRS parameters, scheduling information, or both may be defined for different connectivity states. The indicated DMRS parameters and scheduling information may be included in the respective fixed or allowed sets. For example, the network entity 105-a may select the DMRS parameters and the scheduling information from combinations of DMRS parameters (e.g., combinations of S, A, B, and x) and scheduling values (e.g., combinations of K₀, L₀, and M) that are defined for a given connectivity state of the UE 115-a. By indicating DMRS parameters and scheduling information in accordance with fixed or allowed sets that correspond to a connectivity state of the UE 115-a, the network entity 105-a may ensure that the time domain resource allocation is supported by the UE 115-a.

The allowed combinations of DMRS parameters may be referred to as T_{1,State}={S̅, Ā, B̅, x̅}, where “1” indicates that the time domain allocation parameters are DMRS parameters (e.g., indicated in the RRC message 215) and the “state” corresponds to a connectivity state of the UE 115-a. The allowed combinations of scheduling values may be referred to as T_{2,State}={K̅₀, L̅₀, M̅}, where “2” indicates that the time domain allocation parameters are scheduling parameters (e.g., indicated in the DCI message 220).

For example, allowed combinations of DMRS parameters T_{1,Idle}={S̅, Ā, B̅, x̅} and scheduling values T_{2,Idle}={K̅₀, L̅₀, M} may be defined for an RRC idle state. The set of combinations of DMRS parameters may be stored in a memory 205-a of the UE 115-a, a memory 205-b of the network entity 105-a, or both (e.g., hard coded). Alternatively, the set of combinations of DMRS parameters may be cell-specific. In such examples, the network entity 105-a may broadcast the set of combinations of DMRS parameters via a SIB (e.g., via a PDSCH-ConfigCommon using SIB1). The set of combinations of DMRS parameters may correspond to default parameters used when a DMRS configuration is not yet communicated (e.g., when DMRS-DownlinkConfig information element (IE) is yet to be configured by upper layers). The DCI message 220 (e.g., DCI 1_0) may index entries from the set T_{2,Idle} T_{2,Idle}. The set of scheduling values may be stored in a memory 205-a of the UE 115-a, a memory 205-b of the network entity 105-a, or both (e.g., hard coded). For example, the set of scheduling values may be included in a table stored in memory (e.g., pdsch-TimeDomainAllocationList tables). Additionally, or alternatively, the set of scheduling values may be indicated via a broadcast message (e.g., using a PDSCH-ConfigCommon IE in SIB1).

A different fixed set of combinations of DMRS parameters may be defined for an RRC connected mode prior to or after receipt of an RRC reconfiguration message based on a capability message 210. For example, when the UE 115-a completes an RRC connection setup, the network entity 105-a may assume a set of combinations of the DMRS parameters (e.g., S, A, B, and x) that are different than a set of combinations of the DMRS parameters used in an RRC idle state. An RRC connected mode may refer to a first state in which the UE 115-a has yet to receive an RRC reconfiguration based on capability information of the UE 115-a or a second state in which the UE 115-a has received the RRC reconfiguration from the network entity 105-a and is ready to receive data using UE-specific signaling (e.g., based on the capability information of the UE 115-a). In an RRC connected mode prior to transmission of the capability message 210 (e.g., in the first state of the RRC connected mode), the network entity 105-a may reuse combinations of T_{1,Idle} and T_{2,Idle} for shared channel SLIV-based transmissions. In some aspects, the network entity 105-a may reuse the combinations based on an amount of data to be sent prior to a capability-based RRC reconfiguration being below a threshold. For example, the network entity 105-a may have minimal data to send before any capability-based RRC reconfiguration, so defining a separate set of parameters for the RRC connected mode prior to transmission of the capability message 210 may not be demanded.

In an RRC connected mode after transmission of the capability message 210, allowed combinations of DMRS parameters T_{1,Conn}={S̅, Ā, B̅, x̅} and scheduling values T_{2,Conn}={K̅₀, L̅₀, M̅} may be defined. The combinations of DMRS parameters and scheduling values T_{1,Conn} and T_{2,Conn} may be different from T_{1,Idle} and T_{2,Idle}. For example, the RRC connected mode may be associated with a different set of allowed DMRS parameters and scheduling values than the RRC idle mode, the RRC connected mode prior to the capability message 210, or both. In some aspects, the combinations of DMRS parameters and scheduling values T_{1,Conn} and T_{2,Conn} may be based on the capability message 210 (e.g., based on the capability of the UE 115-a).

In some aspects, the allowed DMRS parameters S, A, and E may be based on a DMRS processing capability of the UE 115-a, such as a front of SLIV channel extrapolation capability, in addition to a channel doppler, a carrier to interference noise ratio (CINR), a modulation and coding scheme (MCS), a storage capability of the UE 115-a, or other parameters. A front of SLIV channel extrapolation capability may refer to a threshold (e.g., maximum) amount of data (e.g., in terms of a quantity of data symbols) that the UE 115-a is capable of storing before processing a first DMRS of the SLIV. If a front DMRS offset (e.g., the starting DMRS offset 250) exceeds the quantity of data symbols, the UE 115-a may overwrite a storage buffer and lose some data. Such loss of data may be avoided in accordance with the front of SLIV channel extrapolation capability. Additionally, or alternatively, the allowed quantity of DMRS instances M may be based on a threshold TBS supported by the UE 115-a, which may be based on a HARQ soft buffer size threshold for log likelihood ratios (LLRs) associated with the UE 115-a. For example, with fluid SLIVs, packet scheduling may use longer PDSCH or PUSCH allocations instead of multiple back-to-back slot scheduling, and thus the limiting factor for PDSCH or PUSCH allocation length with fluid SLIVs may be the soft buffer size (e.g., and not the slot size). Accordingly, the allowed quantity of DMRS instances M̅ (which may be referred to as allowed sets of {M}) to be supported may be selected by the network entity 105-a based on the maximum TBS capability indicated by the UE 115-a. For example, the UE 115-a may indicate the threshold TBS in the capability message 210, and the allowed quantities of DMRS instances may be based on the threshold TBS. For example, the network entity 105-a may select allowed quantities of DMRS instances (e.g., in combinations of DMRS parameters T_{1,Conn}) such that a largest M̅ in the set corresponds to a TBS that is smaller than or equal to the threshold TBS for any of the allowed DMRS spacings, starting DMRS offsets, ending DMRS offsets, and threshold DMRS lengths. For example, the DMRS parameters included in T_{1,Conn} may satisfy the threshold TBS (e.g., the set of {M} may be selected such that the largest value in the set will result in a TBS which is smaller or equal to the max TBS for any of the S/A/B/x choices).

The DMRS parameters included in the allowed combinations of DMRS parameters may correspond to a physical cell identity (PCI). For example, T_{1,Idle} may include PCI-specific values. In some aspects, the DMRS parameters included in the allowed combinations of DMRS parameters may be stored in the memory 205-b of the network entity, the memory 205-a of the UE 115-a, or both. Additionally, or alternatively, the allowed scheduling values included in T_{2,Idle}, T_{2,Conn}, or both may be defined via a time domain resource allocation (TDRA) table. The TDRA table may be stored in the memory 205-a, the memory 205-b, or both or configured via the RRC message 215 (e.g., RRC-configured). The DCI message 220 may indicate the scheduling values by indicating a row index of the TDRA table based on the connectivity state of the UE 115-a.

For example, T_{2,State} may be defined according to Table 1 below. In Table 1, M_max may be based on T_{1,Conn} values for an RRC connected state. Alternatively, for an RRC idle state, M_max may be set as a default (e.g., stored in the memory 205-a, the memory 205-b, or both) or be based on T_{1,Idle} values.

TABLE 1

| | Slot Offset | Starting Symbol | Quantity of DMRS |
|---|---|---|---|
| Row Index | (K₀) | (L₀) | Instances (M) |
| 1 | 0 | 2 | 1 |
| 2 | 0 | 2 | 2 |
| 3 | 0 | 3 | 1 |
| 4 | 0 | 3 | 2 |
| . | . | . | . |
| . | . | . | . |
| . | . | . | . |
| N − 1 | 0 | 2 | . |
| N | 0 | 3 | M_max |

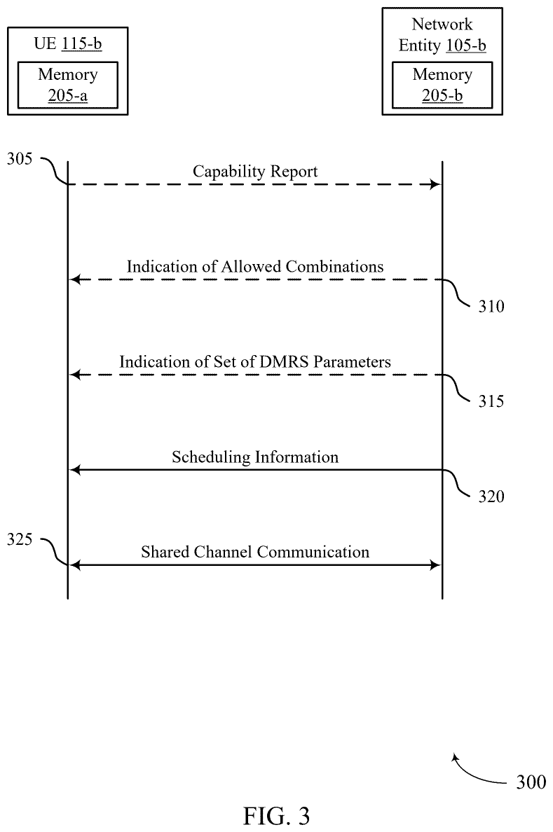

FIG. 3 shows an example of a process flow 300 that supports DMRS time domain allocation for fluid SLIVs in accordance with one or more aspects of the present disclosure. The process flow 300 may implement or be implemented by aspects of the wireless communication system 100, the wireless communication system 200, or both. For example, the process flow 300 may include a UE 115-b and a network entity 105-b, which may be examples of corresponding devices as described with reference to FIGS. 1 and 2.

Alternative examples of the following may be implemented, where some operations are performed in a different order than described or are not performed at all. In some aspects, operations may include additional features not mentioned below, or further operations may be added. Although the UE 115-b and the network entity 105-b are shown performing the operations of the process flow 300, some aspects of some operations may also be performed by one or more other wireless devices.

In some aspects, at 305, the UE 115-b may transmit a capability report to the network entity 105-b. For example, the UE 115-b may transmit a capability report that indicates a capability of the UE 115-b for communication of shared channel transmissions. The capability of the UE 115-b may include a DMRS processing capability of the UE 115-b, a threshold TBS capability of the UE 115-b, or both. The capability report may be an example of the capability message 210 described with reference to FIG. 2.

In some aspects, transmission of the capability report at 305 may be associated with a connectivity state of the UE 115-b. For example, the connectivity state of the UE 115-b may include one of an initial access state with respect to the network entity 105-b, an RRC inactive state with respect to the network entity 105-b, an RRC idle state with respect to the network entity 105-b, an RRC connected state prior to capability reporting, or an RRC connected state after receipt of a configuration message. In some aspects, the UE 115-b may receive a configuration message (e.g., an RRC reconfiguration message) based on the capability report. In such aspects, transmission of the capability report at 305 may be indicative of a change of a connectivity state of the UE 115-b from an RRC connected state prior to capability reporting to an RRC connected state after receipt of a configuration message.

In some aspects, at 310, the network entity 105-b may output an indication of allowed combinations to the UE 115-b. The allowed combinations may be based on a connectivity state of the UE 115-b. In examples in which the connectivity state is the initial access state, the RRC idle state, the RRC inactive state, or the RRC connected state prior to capability reporting, the UE 115-b may receive an indication of allowed sets of DMRS parameters in association with the connectivity state. For example, the UE 115-b may receive an indication of allowed sets of combinations of starting slots, starting symbols within starting slots, and quantities of DMRS instances for shared channel communications. In some aspects, receiving the indication of the allowed sets of combinations may include receiving a broadcast message that includes the indication of the allowed sets of DMRS parameters and the indication of the allowed sets of combinations. Alternatively, receiving the indication of the allowed sets of DMRS parameters and the indication of the allowed sets of combinations based on the connectivity state may include obtaining the allowed sets from the memory 205-a of the UE 115-b.

In some aspects, at 315, the network entity 105-b may output an indication of a set of DMRS parameters to the UE 115-b. For example, the UE 115-b may receive an indication of a set of DMRS parameters, where the set of DMRS parameters is indicative of one or more DMRS offsets and a DMRS spacing. The set of DMRS parameters may be in accordance with the capability of the UE 115-b for communication of shared channel transmissions, including the DMRS processing capability, the threshold TBS capability, or both. Additionally, or alternatively, the set of DMRS parameters may be in accordance with the connectivity state of the UE 115-b.

The one or more DMRS offsets may include a starting DMRS offset 250 and an ending DMRS offset 265, and the DMRS spacing may be an example of the DMRS spacing 260 as described with reference to FIG. 2. For example, a first DMRS offset of the one or more DMRS offsets may be from a first data symbol, in time, of one or more data symbols of the shared channel communication and a first DMRS symbol, in time, of the quantity of DMRS instances of the shared channel communication. A second DMRS offset of the one or more DMRS offsets may be from a last data symbol, in time, of the one or more data symbols and a last DMRS symbol, in time, of the quantity of DMRS instances. The DMRS spacing may include a quantity of symbols between adjacent DMRS instances, in time, of the quantity of DMRS instances. In some aspects, the set of DMRS parameters may include a DMRS threshold parameter indicative of a threshold quantity of DMRS symbols per DMRS instance of the quantity of DMRS instances.

In some aspects, receiving the indication of the set of DMRS parameters at 315 may include receiving a control message that includes the indication of the set of DMRS parameters in accordance with the capability of the UE 115-b indicated at 305. For example, the indication of the set of DMRS parameters may be received at 315 via the control message. The set of DMRS parameters may be in accordance with the capability of the UE 115-b. The control message may be an example of an RRC message, such as the RRC message 215 described with reference to FIG. 2.

At 320, the network entity 105-b may output scheduling information to the UE 115-b. For example, the UE 115-b may receive scheduling information for a shared channel communication. The scheduling information may indicate a starting slot for the shared channel communication, a starting symbol within the starting slot for the shared channel communication, and a quantity of DMRS instances for the shared channel communication. The starting slot and the starting symbol may be examples of the starting slot 240 and the starting symbol 245 as described with reference to FIG. 2.

In some aspects, the scheduling information may be in accordance with the capability of the UE 115-b for communication of shared channel transmissions, including the DMRS processing capability, the threshold TBS capability, or both. Additionally, or alternatively, the scheduling information may be in accordance with the connectivity state of the UE 115-b. For example, the quantity of DMRS instances may be based on the threshold TBS capability. Additionally, or alternatively, the scheduling information may indicate an allowed combination from the allowed sets of combinations (e.g., that are based on the connectivity state).

In some aspects, the scheduling information may be conveyed via a control message that indicates one or more rows in a TDRA table. The one or more rows in the TDRA table may indicate the starting slot, the starting symbol, and the quantity of DMRS instances. In some aspects, the control message may be a DCI message, such as the DCI message 220 as described with reference to FIG. 2.

At 325, the UE 115-b and the network entity 105-b may perform shared channel communication. For example, the UE 115-b and the network entity 105-b may perform the shared channel communication in accordance with the scheduling information. The shared channel communication may be an example of or include the shared channel communication 225 described with reference to FIG. 2. For example, the shared channel communication may be a PDSCH communication or a PUSCH communication. A time domain length of the shared channel communication may be based on the one or more DMRS offsets, the DMRS spacing, and the quantity of DMRS instances. In some aspects, the time domain length may also be based on the threshold quantity of DMRS symbols per DMRS instance.

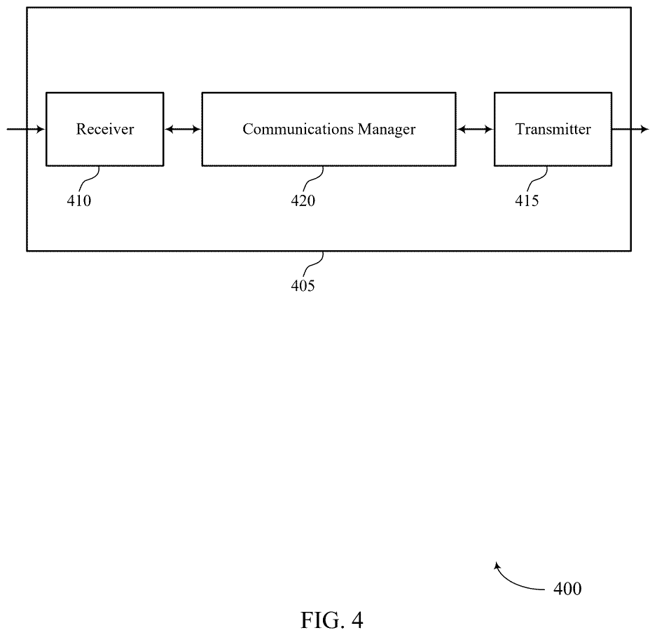

FIG. 4 shows a block diagram 400 of a device 405 that supports DMRS time domain allocation for fluid SLIVs in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to DMRS time domain allocation for fluid SLIVs). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to DMRS time domain allocation for fluid SLIVs). In some aspects, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of DMRS time domain allocation for fluid SLIVs as described herein. For example, the communications manager 420, the receiver 410, the transmitter 415, or various combinations or components thereof may be capable of performing one or more of the functions described herein.

In some aspects, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving an indication of a set of DMRS parameters, where the set of DMRS parameters is indicative of one or more DMRS offsets and a DMRS spacing. The communications manager 420 is capable of, configured to, or operable to support a means for receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The communications manager 420 is capable of, configured to, or operable to support a means for performing the shared channel communication in accordance with the scheduling information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

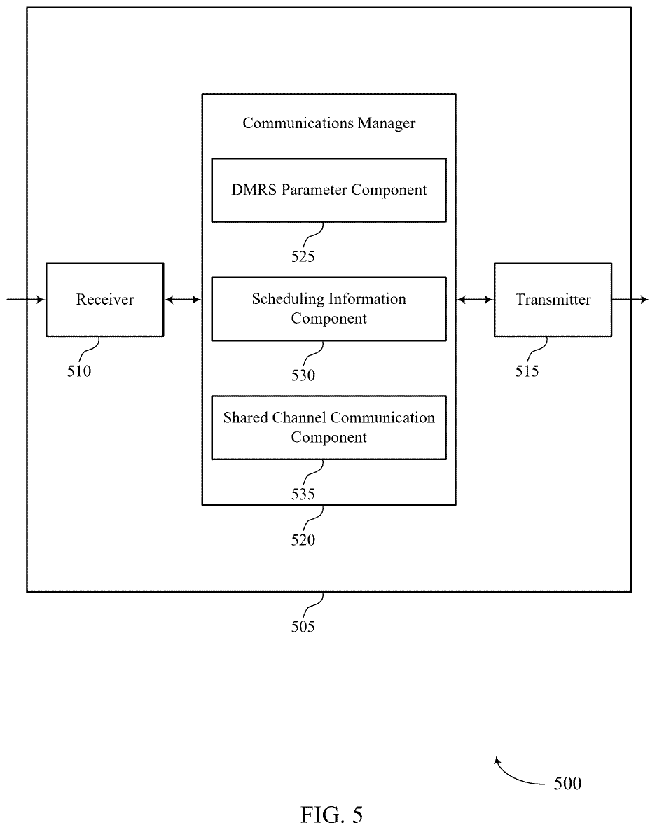

FIG. 5 shows a block diagram 500 of a device 505 that supports DMRS time domain allocation for fluid SLIVs in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DMRS time domain allocation for fluid SLIVs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DMRS time domain allocation for fluid SLIVs). In some aspects, the transmitter 515 may be co-located with a receiver 510 in a transceiver module. The transmitter 515 may utilize a single antenna or a set of multiple antennas.

The device 505, or various components thereof, may be an example of means for performing various aspects of DMRS time domain allocation for fluid SLIVs as described herein. For example, the communications manager 520 may include a DMRS parameter component 525, a scheduling information component 530, a shared channel communication component 535, or any combination thereof. The communications manager 520 may be an example of aspects of a communications manager 420 as described herein. In some aspects, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The DMRS parameter component 525 is capable of, configured to, or operable to support a means for receiving an indication of a set of DMRS parameters, where the set of DMRS parameters is indicative of one or more DMRS offsets and a DMRS spacing. The scheduling information component 530 is capable of, configured to, or operable to support a means for receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The shared channel communication component 535 is capable of, configured to, or operable to support a means for performing the shared channel communication in accordance with the scheduling information.

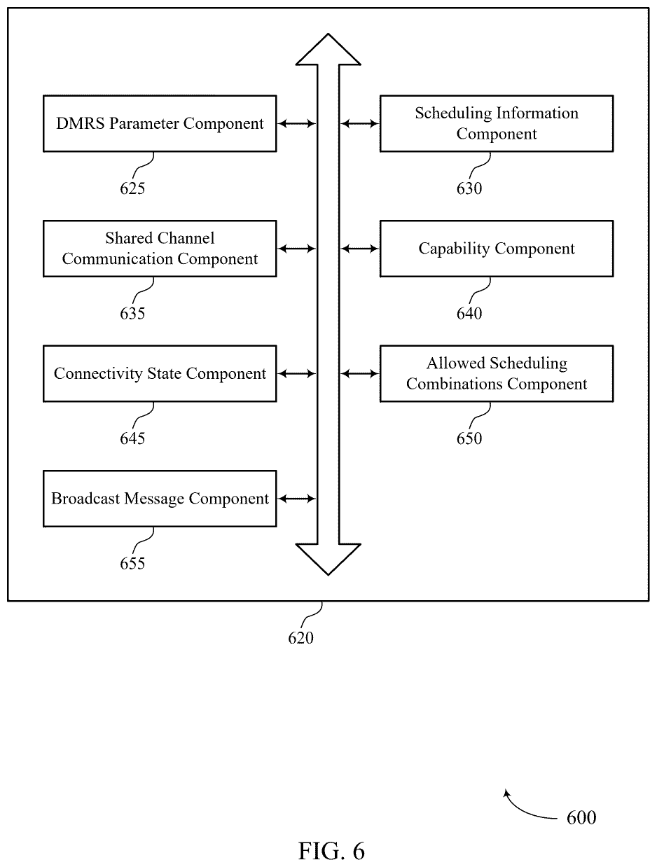

FIG. 6 shows a block diagram 600 of a communications manager 620 that supports DMRS time domain allocation for fluid SLIVs in accordance with one or more aspects of the present disclosure. The communications manager 620 may be an example of aspects of a communications manager 420, a communications manager 520, or both, as described herein. The communications manager 620, or various components thereof, may be an example of means for performing various aspects of DMRS time domain allocation for fluid SLIVs as described herein. For example, the communications manager 620 may include a DMRS parameter component 625, a scheduling information component 630, a shared channel communication component 635, a capability component 640, a connectivity state component 645, an allowed scheduling combinations component 650, a broadcast message component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The DMRS parameter component 625 is capable of, configured to, or operable to support a means for receiving an indication of a set of DMRS parameters, where the set of DMRS parameters is indicative of one or more DMRS offsets and a DMRS spacing. The scheduling information component 630 is capable of, configured to, or operable to support a means for receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The shared channel communication component 635 is capable of, configured to, or operable to support a means for performing the shared channel communication in accordance with the scheduling information.

In some aspects, a first DMRS offset of the one or more DMRS offsets is from a first data symbol, in time, of one or more data symbols of the shared channel communication and a first DMRS symbol, in time, of the quantity of DMRS instances of the shared channel communication, a second DMRS offset of the one or more DMRS offsets is from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

In some aspects, the set of DMRS parameters further includes a DMRS threshold parameter, the DMRS threshold parameter indicative of a threshold quantity of DMRS symbols per DMRS instance of the quantity of DMRS instances. In some aspects, the time domain length of the shared channel communication is based on the threshold quantity of DMRS symbols per DMRS instance.

In some aspects, at least one of the set of DMRS parameters or the scheduling information is based on a connectivity state of the network entity. In some aspects, the connectivity state is associated a set of allowed shared channel communication time domain lengths. In some aspects, the set of allowed shared channel communication time domain lengths includes the time domain length of the shared channel communication.

In some aspects, the connectivity state includes one of an initial access state with respect to a second network entity, a RRC inactive state with respect to the second network entity, a RRC idle state with respect to the second network entity, a RRC connected state prior to capability reporting, or a RRC connected state after receipt of a configuration message.

In some aspects, the connectivity state is the initial access state, the RRC idle state, the RRC inactive state, or the RRC connected state prior to capability reporting, and the connectivity state component 645 is capable of, configured to, or operable to support a means for receiving an indication of allowed sets of DMRS parameters in association with the connectivity state, the allowed sets of DMRS parameters including the set of DMRS parameters. In some aspects, the connectivity state is the initial access state, the RRC idle state, the RRC inactive state, or the RRC connected state prior to capability reporting, and the allowed scheduling combinations component 650 is capable of, configured to, or operable to support a means for receiving an indication of allowed sets of combinations of starting slots, starting symbols within starting slots, and quantities of DMRS instances for shared channel communications, where the scheduling information indicates an allowed combination from the allowed sets of combinations.

In some aspects, to support receiving the indication of the allowed sets of DMRS parameters and the indication of the allowed sets of combinations, the broadcast message component 655 is capable of, configured to, or operable to support a means for receiving a broadcast message that includes the indication of the allowed sets of DMRS parameters and the indication of the allowed sets of combinations.

In some aspects, to support receiving the indication of the allowed sets of DMRS parameters and the indication of the allowed sets of combinations, the connectivity state component 645 is capable of, configured to, or operable to support a means for receiving, from memory of the network entity, the indication of the allowed sets of DMRS parameters and the indication of the allowed sets of combinations based on the connectivity state.

In some aspects, the capability component 640 is capable of, configured to, or operable to support a means for transmitting a capability report that indicates a capability of the network entity for communication of shared channel transmissions, where, to receive the indication of the set of DMRS parameters, the method includes receiving a control message that includes the indication of the set of DMRS parameters in accordance with the capability of the network entity.

In some aspects, the scheduling information is in accordance with the capability of the network entity. Additionally, or alternatively, the capability report indicates a DMRS processing capability of the network entity, and the set of DMRS parameters are in accordance with the DMRS processing capability. In some aspects, the capability report indicates a threshold TBS capability associated with the network entity, and the quantity of DMRS instances is based on the threshold TBS capability.

In some aspects, to support receiving the scheduling information, the scheduling information component 630 is capable of, configured to, or operable to support a means for receiving a control message that indicates one or more rows in a TDRA table, where the one or more rows in the TDRA table indicate the starting slot, the starting symbol, and the quantity of DMRS instances.

In some aspects, the indication of the set of DMRS parameters is received via an RRC message. In some aspects, the scheduling information is received via a DCI message.

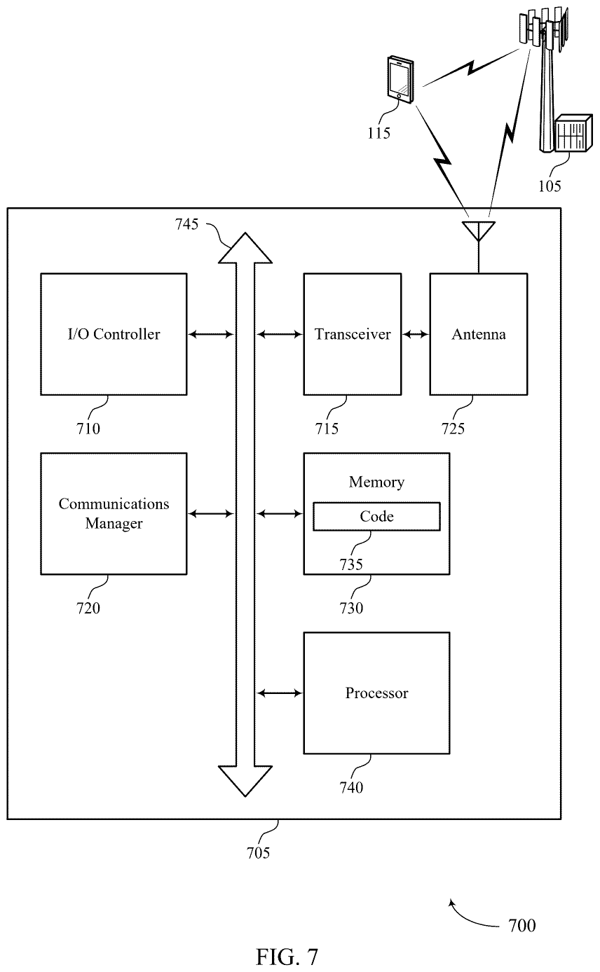

FIG. 7 shows a diagram of a system 700 including a device 705 that supports DMRS time domain allocation for fluid SLIVs in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting DMRS time domain allocation for fluid SLIVs). For example, the device 705 or a component of the device 705 may include at least one processor 740 and at least one memory 730 coupled with or to the at least one processor 740, the at least one processor 740 and the at least one memory 730 configured to perform various functions described herein.

In some aspects, the at least one processor 740 may include multiple processors and the at least one memory 730 may include multiple memories. One or more of the multiple processors may be coupled with one or more of the multiple memories, which may, individually or collectively, be configured to perform various functions described herein. In some aspects, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving an indication of a set of DMRS parameters, where the set of DMRS parameters is indicative of one or more DMRS offsets and a DMRS spacing. The communications manager 720 is capable of, configured to, or operable to support a means for receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The communications manager 720 is capable of, configured to, or operable to support a means for performing the shared channel communication in accordance with the scheduling information.

By including or configuring the communications manager 720 in accordance with examples as described herein, the device 705 may support techniques for improved user experience related to reduced processing, reduced power consumption, more efficient utilization of communication resources, improved coordination between devices, and improved utilization of processing capability.

In some aspects, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, In some aspects, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of DMRS time domain allocation for fluid SLIVs as described herein, or the at least one processor 740 and the at least one memory 730 may be otherwise configured to, individually or collectively, perform or support such operations.

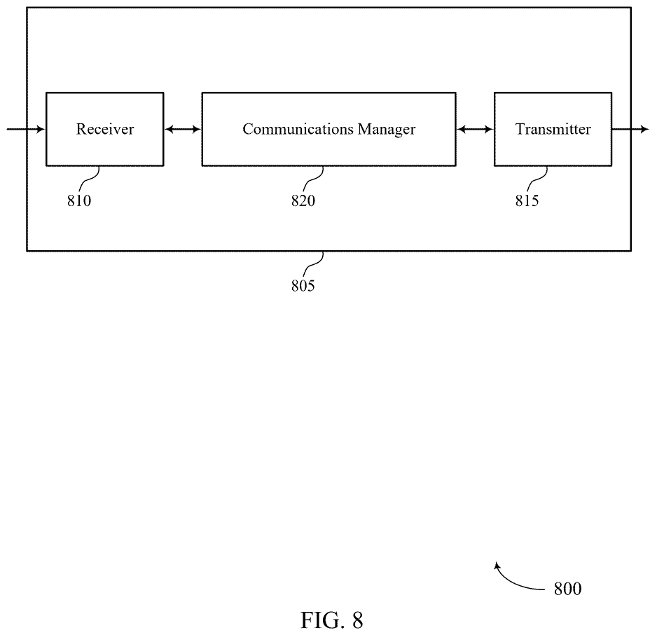

FIG. 8 shows a block diagram 800 of a device 805 that supports DMRS time domain allocation for fluid SLIVs in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some aspects, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some aspects, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of DMRS time domain allocation for fluid SLIVs as described herein. For example, the communications manager 820, the receiver 810, the transmitter 815, or various combinations or components thereof may be capable of performing one or more of the functions described herein.

In some aspects, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting or obtaining an indication of a set of DMRS parameters for a second network entity, where the set of DMRS parameters is indicative of one or more DMRS offsets and a DMRS spacing. The communications manager 820 is capable of, configured to, or operable to support a means for outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The communications manager 820 is capable of, configured to, or operable to support a means for performing the shared channel communication with the second network entity in accordance with the scheduling information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

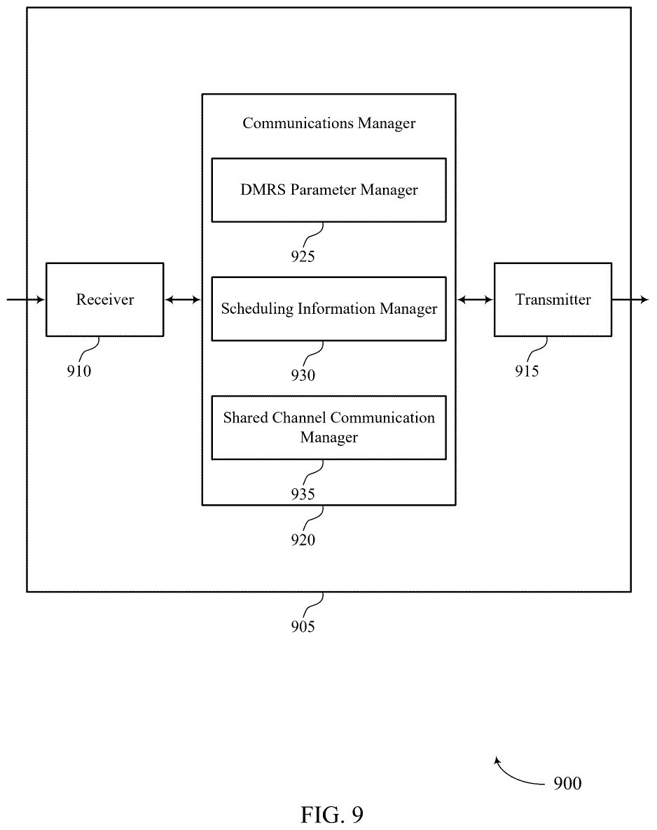

FIG. 9 shows a block diagram 900 of a device 905 that supports DMRS time domain allocation for fluid SLIVs in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some aspects, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some aspects, the transmitter 915 and the receiver 910 may be co-located in a transceiver, which may include or be coupled with a modem.

The device 905, or various components thereof, may be an example of means for performing various aspects of DMRS time domain allocation for fluid SLIVs as described herein. For example, the communications manager 920 may include a DMRS parameter manager 925, a scheduling information manager 930, a shared channel communication manager 935, or any combination thereof. The communications manager 920 may be an example of aspects of a communications manager 820 as described herein. In some aspects, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The DMRS parameter manager 925 is capable of, configured to, or operable to support a means for outputting or obtaining an indication of a set of DMRS parameters for a second network entity, where the set of DMRS parameters is indicative of one or more DMRS offsets and a DMRS spacing. The scheduling information manager 930 is capable of, configured to, or operable to support a means for outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The shared channel communication manager 935 is capable of, configured to, or operable to support a means for perform the shared channel communication with the second network entity in accordance with the scheduling information.

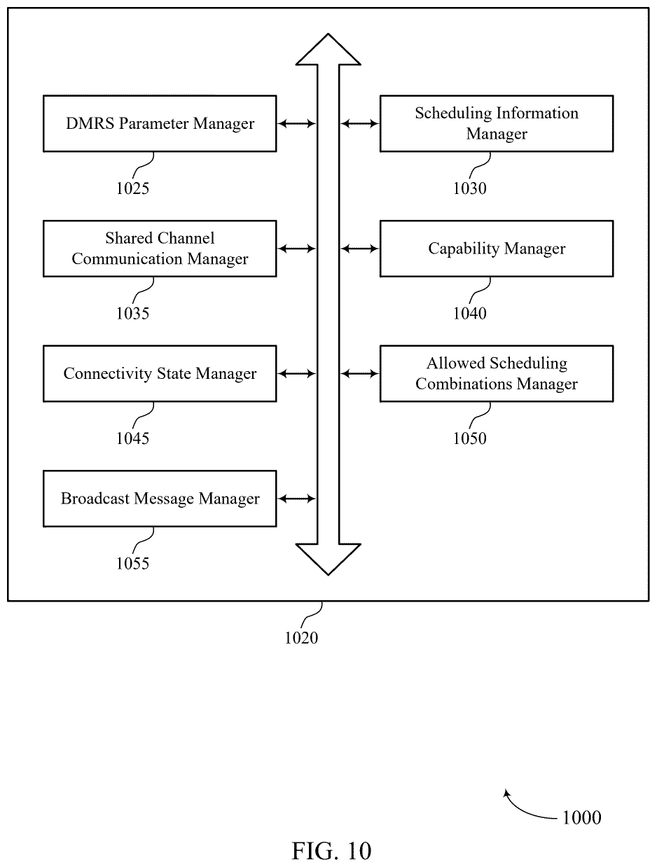

FIG. 10 shows a block diagram 1000 of a communications manager 1020 that supports DMRS time domain allocation for fluid SLIVs in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of DMRS time domain allocation for fluid SLIVs as described herein. For example, the communications manager 1020 may include a DMRS parameter manager 1025, a scheduling information manager 1030, a shared channel communication manager 1035, a capability manager 1040, a connectivity state manager 1045, an allowed scheduling combinations manager 1050, a broadcast message manager 1055, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The DMRS parameter manager 1025 is capable of, configured to, or operable to support a means for outputting or obtaining an indication of a set of DMRS parameters for a second network entity, where the set of DMRS parameters is indicative of one or more DMRS offsets and a DMRS spacing. The scheduling information manager 1030 is capable of, configured to, or operable to support a means for outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The shared channel communication manager 1035 is capable of, configured to, or operable to support a means for perform the shared channel communication with the second network entity in accordance with the scheduling information.

In some aspects, a first DMRS offset of the one or more DMRS offsets is from a first data symbol, in time, of one or more data symbols of the shared channel communication and a first DMRS symbol, in time, of the quantity of DMRS instances of the shared channel communication, a second DMRS offset of the one or more DMRS offsets is from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

In some aspects, the set of DMRS parameters further includes a DMRS threshold parameter, the DMRS threshold parameter indicative of a threshold quantity of DMRS symbols per DMRS instance of the quantity of DMRS instances. In some aspects, the time domain length of the shared channel communication is based on the threshold quantity of DMRS symbols per DMRS instance.

In some aspects, at least one of the set of DMRS parameters or the scheduling information is based on a connectivity state of the second network entity. In some aspects, the connectivity state is associated a set of allowed shared channel communication time domain lengths. In some aspects, the set of allowed shared channel communication time domain lengths includes the time domain length of the shared channel communication.

In some aspects, the connectivity state includes one of an initial access state with respect to the first network entity, a RRC inactive state with respect to the first network entity, a RRC idle state with respect to the first network entity, a RRC connected state prior to capability reporting, or a RRC connected state after receipt of a configuration message.

In some aspects, the connectivity state is the initial access state, the RRC idle state, the RRC inactive state, or the RRC connected state prior to capability reporting, and the connectivity state manager 1045 is capable of, configured to, or operable to support a means for outputting or obtaining an indication of allowed sets of DMRS parameters in association with the connectivity state, the allowed sets of DMRS parameters including the set of DMRS parameters. In some aspects, the connectivity state is the initial access state, the RRC idle state, the RRC inactive state, or the RRC connected state prior to capability reporting, and the allowed scheduling combinations manager 1050 is capable of, configured to, or operable to support a means for outputting or obtaining an indication of allowed sets of combinations of starting slots, starting symbols within starting slots, and quantities of DMRS instances for shared channel communications, where the scheduling information indicates an allowed combination from the allowed sets of combinations.

In some aspects, to support outputting or obtaining the indication of the allowed sets of DMRS parameters and the indication of the allowed sets of combinations, the broadcast message manager 1055 is capable of, configured to, or operable to support a means for outputting a broadcast message that includes the indication of the allowed sets of DMRS parameters and the indication of the allowed sets of combinations.

In some aspects, to support outputting or obtaining the indication of the allowed sets of DMRS parameters and the indication of the allowed sets of combinations, the connectivity state manager 1045 is capable of, configured to, or operable to support a means for obtaining, from memory of the first network entity, the indication of the allowed sets of DMRS parameters and the indication of the allowed sets of combinations based on the connectivity state.

In some aspects, the capability manager 1040 is capable of, configured to, or operable to support a means for obtaining a capability report that indicates a capability of the second network entity for communication of shared channel transmissions where, to output or obtain the indication of the set of DMRS parameters, the method includes outputting a control message that includes the indication of the set of DMRS parameters in accordance with the capability of the second network entity.

In some aspects, the scheduling information is in accordance with the capability of the second network entity.

In some aspects, the capability report indicates a DMRS processing capability of the second network entity. In some aspects, the set of DMRS parameters are in accordance with the DMRS processing capability.

In some aspects, the capability report indicates a threshold TBS capability associated with the second network entity. In some aspects, the quantity of DMRS instances is based on the threshold TBS capability.

In some aspects, to support outputting the scheduling information, the scheduling information manager 1030 is capable of, configured to, or operable to support a means for outputting a control message that indicates one or more rows in a TDRA table, where the one or more rows in the TDRA table indicate the starting slot, the starting symbol, and the quantity of DMRS instances.

In some aspects, the indication of the set of DMRS parameters is output via an RRC message. In some aspects, the scheduling information is output via a DCI message.

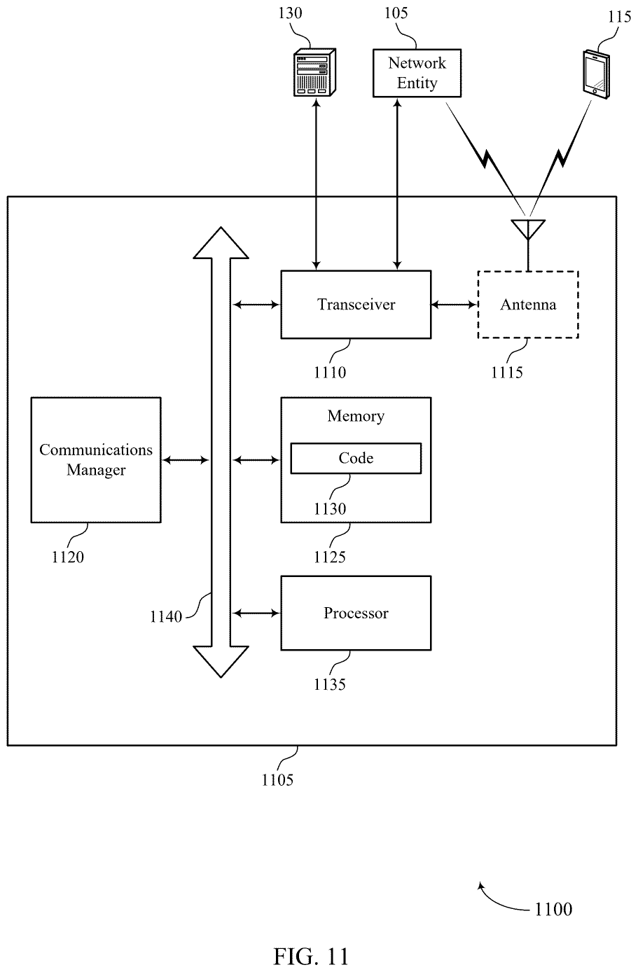

FIG. 11 shows a diagram of a system 1100 including a device 1105 that supports DMRS time domain allocation for fluid SLIVs in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some aspects, the transceiver 1110 may include a wired transceiver and may communicate bi-directionally with another wired transceiver. Additionally, or alternatively, in some aspects, the transceiver 1110 may include a wireless transceiver and may communicate bi-directionally with another wireless transceiver. In some aspects, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some aspects, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some aspects, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting DMRS time domain allocation for fluid SLIVs). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some aspects, the at least one processor 1135 may include multiple processors and the at least one memory 1125 may include multiple memories. One or more of the multiple processors may be coupled with one or more of the multiple memories, which may, individually or collectively, be configured to perform various functions herein. In some aspects, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some aspects, a bus 1140 may support communications of (e.g., within) a protocol layer of a protocol stack. In some aspects, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some aspects, the communications manager 1120 may manage aspects of communications with a core network 130 (e.g., via one or more wired or wireless backhaul links). For example, the communications manager 1120 may manage the transfer of data communications for client devices, such as one or more UEs 115. In some aspects, the communications manager 1120 may manage communications with one or more other network entities 105, and may include a controller or scheduler for controlling communications with UEs 115 (e.g., in cooperation with the one or more other network devices). In some aspects, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting or obtaining an indication of a set of DMRS parameters for a second network entity, where the set of DMRS parameters is indicative of one or more DMRS offsets and a DMRS spacing. The communications manager 1120 is capable of, configured to, or operable to support a means for outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The communications manager 1120 is capable of, configured to, or operable to support a means for performing the shared channel communication with the second network entity in accordance with the scheduling information.

By including or configuring the communications manager 1120 in accordance with examples as described herein, the device 1105 may support techniques for improved communication reliability, improved user experience related to reduced processing, reduced power consumption, more efficient utilization of communication resources, improved coordination between devices, longer battery life, and improved utilization of processing capability.

In some aspects, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, In some aspects, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of DMRS time domain allocation for fluid SLIVs as described herein, or the at least one processor 1135 and the at least one memory 1125 may be otherwise configured to, individually or collectively, perform or support such operations.

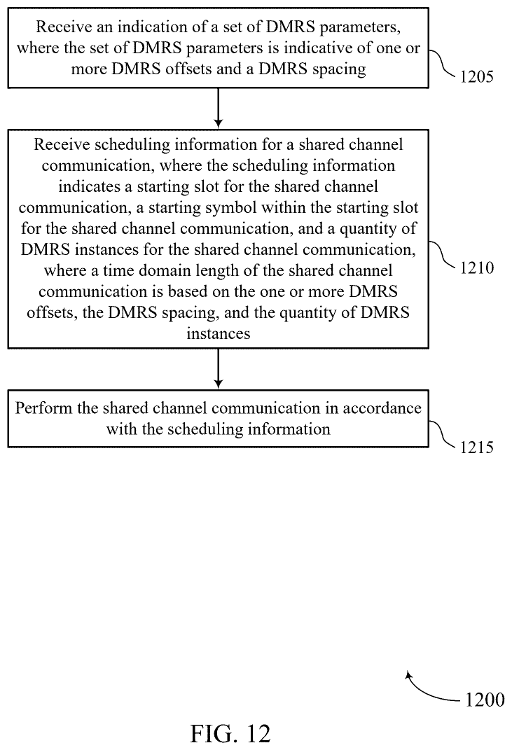

FIG. 12 shows a flowchart illustrating a method 1200 that supports DMRS time domain allocation for fluid SLIVs in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some aspects, a UE may execute a set of instructions to control the functional elements of the UE to perform the described functions. Additionally, or alternatively, the UE may perform aspects of the described functions using special-purpose hardware.

At 1205, the method may include receiving an indication of a set of DMRS parameters, where the set of DMRS parameters is indicative of one or more DMRS offsets and a DMRS spacing. The operations of 1205 may be performed in accordance with examples as disclosed herein. In some aspects, aspects of the operations of 1205 may be performed by a DMRS parameter component 625 as described with reference to FIG. 6.

At 1210, the method may include receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The operations of 1210 may be performed in accordance with examples as disclosed herein. In some aspects, aspects of the operations of 1210 may be performed by a scheduling information component 630 as described with reference to FIG. 6.

At 1215, the method may include performing the shared channel communication in accordance with the scheduling information. The operations of 1215 may be performed in accordance with examples as disclosed herein. In some aspects, aspects of the operations of 1215 may be performed by a shared channel communication component 635 as described with reference to FIG. 6.

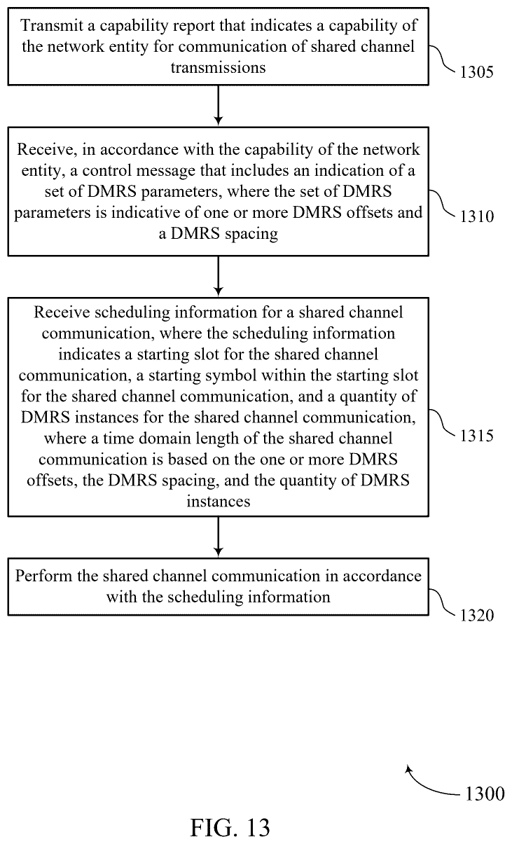

FIG. 13 shows a flowchart illustrating a method 1300 that supports DMRS time domain allocation for fluid SLIVs in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some aspects, a UE may execute a set of instructions to control the functional elements of the UE to perform the described functions. Additionally, or alternatively, the UE may perform aspects of the described functions using special-purpose hardware.

At 1305, the method may include transmitting a capability report that indicates a capability of the network entity for communication of shared channel transmissions. The operations of 1305 may be performed in accordance with examples as disclosed herein. In some aspects, aspects of the operations of 1305 may be performed by a capability component 640 as described with reference to FIG. 6.

At 1310, the method may include receiving, in accordance with the capability of the network entity, a control message that includes an indication of a set of DMRS parameters, where the set of DMRS parameters is indicative of one or more DMRS offsets and a DMRS spacing. The operations of 1310 may be performed in accordance with examples as disclosed herein. In some aspects, aspects of the operations of 1310 may be performed by a DMRS parameter component 625 as described with reference to FIG. 6.

At 1315, the method may include receiving scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The operations of 1315 may be performed in accordance with examples as disclosed herein. In some aspects, aspects of the operations of 1315 may be performed by a scheduling information component 630 as described with reference to FIG. 6.

At 1320, the method may include performing the shared channel communication in accordance with the scheduling information. The operations of 1320 may be performed in accordance with examples as disclosed herein. In some aspects, aspects of the operations of 1320 may be performed by a shared channel communication component 635 as described with reference to FIG. 6.

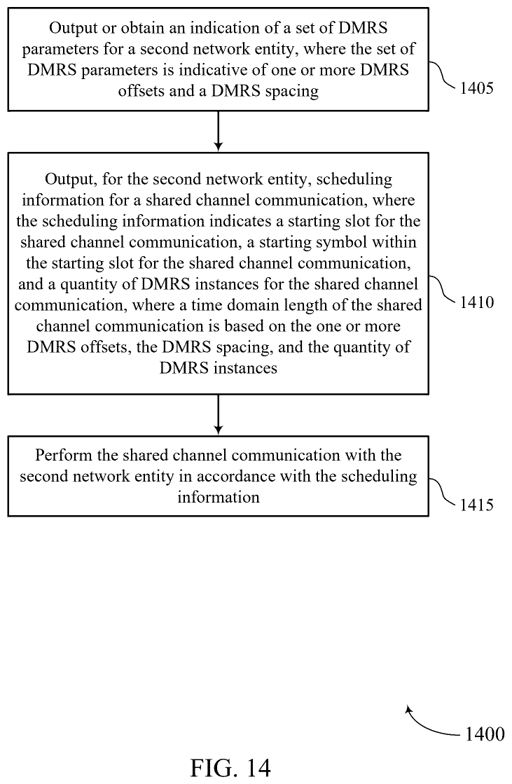

FIG. 14 shows a flowchart illustrating a method 1400 that supports DMRS time domain allocation for fluid SLIVs in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some aspects, a network entity may execute a set of instructions to control the functional elements of the network entity to perform the described functions. Additionally, or alternatively, the network entity may perform aspects of the described functions using special-purpose hardware.

At 1405, the method may include outputting or obtaining an indication of a set of DMRS parameters for a second network entity, where the set of DMRS parameters is indicative of one or more DMRS offsets and a DMRS spacing. The operations of 1405 may be performed in accordance with examples as disclosed herein. In some aspects, aspects of the operations of 1405 may be performed by a DMRS parameter manager 1025 as described with reference to FIG. 10.

At 1410, the method may include outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The operations of 1410 may be performed in accordance with examples as disclosed herein. In some aspects, aspects of the operations of 1410 may be performed by a scheduling information manager 1030 as described with reference to FIG. 10.

At 1415, the method may include perform the shared channel communication with the second network entity in accordance with the scheduling information. The operations of 1415 may be performed in accordance with examples as disclosed herein. In some aspects, aspects of the operations of 1415 may be performed by a shared channel communication manager 1035 as described with reference to FIG. 10.

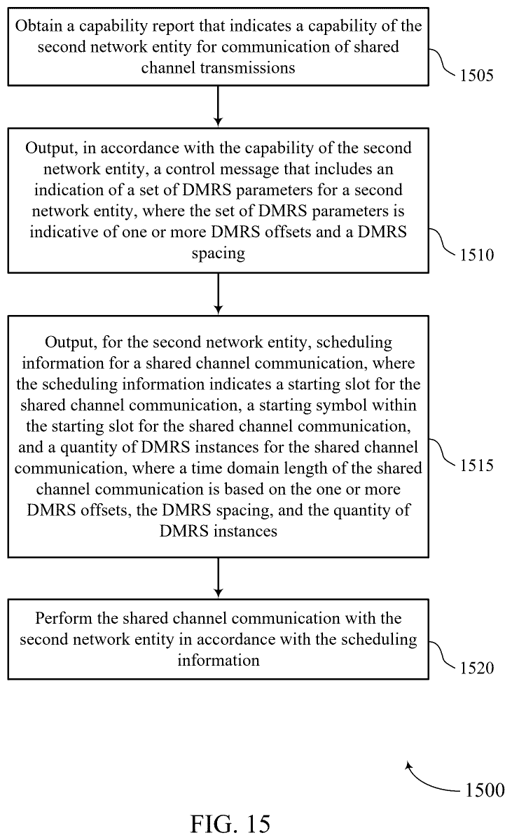

FIG. 15 shows a flowchart illustrating a method 1500 that supports DMRS time domain allocation for fluid SLIVs in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some aspects, a network entity may execute a set of instructions to control the functional elements of the network entity to perform the described functions. Additionally, or alternatively, the network entity may perform aspects of the described functions using special-purpose hardware.

At 1505, the method may include obtaining a capability report that indicates a capability of the second network entity for communication of shared channel transmissions. The operations of 1505 may be performed in accordance with examples as disclosed herein. In some aspects, aspects of the operations of 1505 may be performed by a capability manager 1040 as described with reference to FIG. 10.

At 1510, the method may include outputting, in accordance with the capability of the second network entity, a control message that includes an indication of a set of DMRS parameters for a second network entity, where the set of DMRS parameters is indicative of one or more DMRS offsets and a DMRS spacing. The operations of 1510 may be performed in accordance with examples as disclosed herein. In some aspects, aspects of the operations of 1510 may be performed by a DMRS parameter manager 1025 as described with reference to FIG. 10.

At 1515, the method may include outputting, for the second network entity, scheduling information for a shared channel communication, where the scheduling information indicates a starting slot for the shared channel communication, a starting symbol within the starting slot for the shared channel communication, and a quantity of DMRS instances for the shared channel communication, where a time domain length of the shared channel communication is based on the one or more DMRS offsets, the DMRS spacing, and the quantity of DMRS instances. The operations of 1515 may be performed in accordance with examples as disclosed herein. In some aspects, aspects of the operations of 1515 may be performed by a scheduling information manager 1030 as described with reference to FIG. 10.

At 1520, the method may include perform the shared channel communication with the second network entity in accordance with the scheduling information. The operations of 1520 may be performed in accordance with examples as disclosed herein. In some aspects, aspects of the operations of 1520 may be performed by a shared channel communication manager 1035 as described with reference to FIG. 10.

The following provides an overview of aspects of the present disclosure:

Aspect 1: A method of wireless communications at a network entity, comprising: receiving an indication of a set of DMRS parameters, wherein the set of DMRS parameters is indicative of one or more DMRS offsets and a DMRS spacing; receiving scheduling information for a shared channel communication, wherein the scheduling information indicates a starting slot for the shared channel communication, a starting symbol within the starting slot for the shared channel communication, and a quantity of DMRS instances for the shared channel communication, wherein a time domain length of the shared channel communication is based on the one or more DMRS offsets, the DMRS spacing, and the quantity of DMRS instances; and performing the shared channel communication in accordance with the scheduling information.

Aspect 2: The method of aspect 1, wherein a first DMRS offset of the one or more DMRS offsets is from a first data symbol, in time, of one or more data symbols of the shared channel communication and a first DMRS symbol, in time, of the quantity of DMRS instances of the shared channel communication, a second DMRS offset of the one or more DMRS offsets is from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

Aspect 3: The method of any of aspects 1 through 2, wherein the set of DMRS parameters further includes a DMRS threshold parameter, the DMRS threshold parameter indicative of a threshold quantity of DMRS symbols per DMRS instance of the quantity of DMRS instances, and the time domain length of the shared channel communication is based on the threshold quantity of DMRS symbols per DMRS instance.

Aspect 4: The method of any of aspects 1 through 3, wherein at least one of the set of DMRS parameters or the scheduling information is based on a connectivity state of the network entity, and the connectivity state is associated a set of allowed shared channel communication time domain lengths, and the set of allowed shared channel communication time domain lengths includes the time domain length of the shared channel communication.

Aspect 5: The method of aspect 4, wherein the connectivity state includes one of an initial access state with respect to a second network entity, an RRC inactive state with respect to the second network entity, an RRC idle state with respect to the second network entity, an RRC connected state prior to capability reporting, or an RRC connected state after receipt of a configuration message.

Aspect 6: The method of aspect 5, wherein the connectivity state is the initial access state, the RRC idle state, the RRC inactive state, or the RRC connected state prior to capability reporting, the method further comprising: receiving an indication of allowed sets of DMRS parameters in association with the connectivity state, the allowed sets of DMRS parameters comprising the set of DMRS parameters; and receiving an indication of allowed sets of combinations of starting slots, starting symbols within starting slots, and quantities of DMRS instances for shared channel communications, wherein the scheduling information indicates an allowed combination from the allowed sets of combinations.

Aspect 7: The method of aspect 6, wherein receiving the indication of the allowed sets of DMRS parameters and the indication of the allowed sets of combinations comprises: receiving a broadcast message that includes the indication of the allowed sets of DMRS parameters and the indication of the allowed sets of combinations.

Aspect 8: The method of any of aspects 6 through 7, wherein receiving the indication of the allowed sets of DMRS parameters and the indication of the allowed sets of combinations comprises: receiving, from memory of the network entity, the indication of the allowed sets of DMRS parameters and the indication of the allowed sets of combinations based on the connectivity state.

Aspect 9: The method of any of aspects 1 through 8, further comprising: transmitting a capability report that indicates a capability of the network entity for communication of shared channel transmissions, wherein, to receive the indication of the set of DMRS parameters, the method comprises receiving a control message that includes the indication of the set of DMRS parameters in accordance with the capability of the network entity.

Aspect 10: The method of aspect 9, wherein the scheduling information is in accordance with the capability of the network entity.

Aspect 11: The method of any of aspects 9 through 10, wherein the capability report indicates a DMRS processing capability of the network entity, and the set of DMRS parameters are in accordance with the DMRS processing capability.

Aspect 12: The method of any of aspects 9 through 11, wherein the capability report indicates a threshold transport block size capability associated with the network entity, and the quantity of DMRS instances is based on the threshold transport block size capability.

Aspect 13: The method of any of aspects 1 through 12, wherein receiving the scheduling information comprises: receiving a control message that indicates one or more rows in a TDRA table, wherein the one or more rows in the TDRA table indicate the starting slot, the starting symbol, and the quantity of DMRS instances.

Aspect 14: The method of any of aspects 1 through 13, wherein the indication of the set of DMRS parameters is received via an RRC message, and the scheduling information is received via a DCI message.

Aspect 15: A method of wireless communications at a first network entity, comprising: outputting or obtaining an indication of a set of DMRS parameters for a second network entity, wherein the set of DMRS parameters is indicative of one or more DMRS offsets and a DMRS spacing; outputting, for the second network entity, scheduling information for a shared channel communication, wherein the scheduling information indicates a starting slot for the shared channel communication, a starting symbol within the starting slot for the shared channel communication, and a quantity of DMRS instances for the shared channel communication, wherein a time domain length of the shared channel communication is based on the one or more DMRS offsets, the DMRS spacing, and the quantity of DMRS instances; and perform the shared channel communication with the second network entity in accordance with the scheduling information.

Aspect 16: The method of aspect 15, wherein a first DMRS offset of the one or more DMRS offsets is from a first data symbol, in time, of one or more data symbols of the shared channel communication and a first DMRS symbol, in time, of the quantity of DMRS instances of the shared channel communication, a second DMRS offset of the one or more DMRS offsets is from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

Aspect 17: The method of any of aspects 15 through 16, wherein the set of DMRS parameters further includes a DMRS threshold parameter, the DMRS threshold parameter indicative of a threshold quantity of DMRS symbols per DMRS instance of the quantity of DMRS instances, and the time domain length of the shared channel communication is based on the threshold quantity of DMRS symbols per DMRS instance.

Aspect 18: The method of any of aspects 15 through 17, wherein at least one of the set of DMRS parameters or the scheduling information is based on a connectivity state of the second network entity, and the connectivity state is associated a set of allowed shared channel communication time domain lengths, and the set of allowed shared channel communication time domain lengths includes the time domain length of the shared channel communication.

Aspect 19: The method of aspect 18, wherein the connectivity state includes one of an initial access state with respect to the first network entity, an RRC inactive state with respect to the first network entity, an RRC idle state with respect to the first network entity, an RRC connected state prior to capability reporting, or an RRC connected state after receipt of a configuration message.

Aspect 20: The method of aspect 19, wherein the connectivity state is the initial access state, the RRC inactive state, the RRC idle state, the RRC inactive state, or the RRC connected state prior to capability reporting, the method further comprising: outputting or obtaining an indication of allowed sets of DMRS parameters in association with the connectivity state, the allowed sets of DMRS parameters comprising the set of DMRS parameters; and outputting or obtaining an indication of allowed sets of combinations of starting slots, starting symbols within starting slots, and quantities of DMRS instances for shared channel communications, wherein the scheduling information indicates an allowed combination from the allowed sets of combinations.

Aspect 21: The method of aspect 20, wherein outputting or obtaining the indication of the allowed sets of DMRS parameters and the indication of the allowed sets of combinations comprises: outputting a broadcast message that includes the indication of the allowed sets of DMRS parameters and the indication of the allowed sets of combinations.

Aspect 22: The method of any of aspects 20 through 21, wherein outputting or obtaining the indication of the allowed sets of DMRS parameters and the indication of the allowed sets of combinations comprises: obtaining, from memory of the first network entity, the indication of the allowed sets of DMRS parameters and the indication of the allowed sets of combinations based on the connectivity state.

Aspect 23: The method of any of aspects 15 through 22, further comprising: obtaining a capability report that indicates a capability of the second network entity for communication of shared channel transmissions wherein, to output or obtain the indication of the set of DMRS parameters, the method comprises outputting a control message that includes the indication of the set of DMRS parameters in accordance with the capability of the second network entity.

Aspect 24: The method of aspect 23, wherein the scheduling information is in accordance with the capability of the second network entity.

Aspect 25: The method of any of aspects 23 through 24, wherein the capability report indicates a DMRS processing capability of the second network entity, and the set of DMRS parameters are in accordance with the DMRS processing capability.

Aspect 26: The method of any of aspects 23 through 25, wherein the capability report indicates a threshold transport block size capability associated with the second network entity, and the quantity of DMRS instances is based on the threshold transport block size capability.

Aspect 27: The method of any of aspects 15 through 26, wherein outputting the scheduling information comprises: outputting a control message that indicates one or more rows in a time domain resource allocation (TDRA) table, wherein the one or more rows in the TDRA table indicate the starting slot, the starting symbol, and the quantity of DMRS instances.

Aspect 28: The method of any of aspects 15 through 27, wherein the indication of the set of DMRS parameters is output via an RRC message, and the scheduling information is output via a DCI message.

Aspect 29: A network entity for wireless communications, comprising a processing system configured to perform a method of any of aspects 1 through 14.

Aspect 30: A network entity for wireless communications, comprising at least one means for performing a method of any of aspects 1 through 14.

Aspect 31: A non-transitory computer-readable medium having code for wireless communication stored thereon that, when executed by a network entity, causes the network entity to perform a method of any of aspects 1 through 14.

Aspect 32: A first network entity for wireless communications, comprising a processing system configured to perform a method of any of aspects 15 through 28.

Aspect 33: A first network entity for wireless communications, comprising at least one means for performing a method of any of aspects 15 through 28.

Aspect 34: A non-transitory computer-readable medium having code for wireless communication stored thereon that, when executed by a network entity, causes the network entity to perform a method of any of aspects 15 through 28.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of” Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, for wireless communication, comprising:
a processing system configured to:
receive an indication of a set of demodulation reference signal (DMRS) parameters, wherein the set of DMRS parameters is indicative of one or more DMRS offsets and a DMRS spacing;
receive scheduling information for a shared channel communication, wherein the scheduling information indicates a starting slot for the shared channel communication, a starting symbol within the starting slot for the shared channel communication, and a quantity of DMRS instances for the shared channel communication, wherein a time domain length of the shared channel communication is based on the one or more DMRS offsets, the DMRS spacing, and the quantity of DMRS instances; and
perform the shared channel communication in accordance with the scheduling information.

2. The network entity of claim 1, wherein:
a first DMRS offset of the one or more DMRS offsets is from a first data symbol, in time, of one or more data symbols of the shared channel communication and a first DMRS symbol, in time, of the quantity of DMRS instances of the shared channel communication,
a second DMRS offset of the one or more DMRS offsets is from a last data symbol, in time, of the one or more data symbols and a last DMRS symbol, in time, of the quantity of DMRS instances, and
the DMRS spacing includes a quantity of symbols between adjacent DMRS instances, in time, of the quantity of DMRS instances.

3. The network entity of claim 1, wherein the set of DMRS parameters further includes a DMRS threshold parameter, the DMRS threshold parameter indicative of a threshold quantity of DMRS symbols per DMRS instance of the quantity of DMRS instances, and wherein the time domain length of the shared channel communication is based on the threshold quantity of DMRS symbols per DMRS instance.

4. The network entity of claim 1, wherein at least one of the set of DMRS parameters or the scheduling information is based on a connectivity state of the network entity, and wherein the connectivity state is associated a set of allowed shared channel communication time domain lengths, and wherein the set of allowed shared channel communication time domain lengths includes the time domain length of the shared channel communication.

5. The network entity of claim 4, wherein the connectivity state includes one of an initial access state with respect to a second network entity, a radio resource control inactive state with respect to the second network entity, a radio resource control idle state with respect to the second network entity, a radio resource control connected state prior to capability reporting, or a radio resource control connected state after receipt of a configuration message.

6. The network entity of claim 5, wherein the connectivity state is the initial access state, the radio resource control idle state, the radio resource control inactive state, or the radio resource control connected state prior to capability reporting, and wherein the processing system is configured to:
receive an indication of allowed sets of DMRS parameters in association with the connectivity state, the allowed sets of DMRS parameters comprising the set of DMRS parameters; and
receive an indication of allowed sets of combinations of starting slots, starting symbols within starting slots, and quantities of DMRS instances for shared channel communications, wherein the scheduling information indicates an allowed combination from the allowed sets of combinations.

7. The network entity of claim 6, wherein, to receive the indication of the allowed sets of DMRS parameters and the indication of the allowed sets of combinations, the processing system is configured to:
receive a broadcast message that includes the indication of the allowed sets of DMRS parameters and the indication of the allowed sets of combinations.

8. The network entity of claim 6, wherein, to receive the indication of the allowed sets of DMRS parameters and the indication of the allowed sets of combinations, the processing system is configured to:
receive, from memory of the network entity, the indication of the allowed sets of DMRS parameters and the indication of the allowed sets of combinations based on the connectivity state.

9. The network entity of claim 1, wherein the processing system is configured to:
transmit a capability report that indicates a capability of the network entity for communication of shared channel transmissions, wherein to receive the indication of the set of DMRS parameters, the processing system is configured to receive a control message that includes the indication of the set of DMRS parameters in accordance with the capability of the network entity.

10. The network entity of claim 9, wherein the scheduling information is in accordance with the capability of the network entity.

11. The network entity of claim 9, wherein the capability report indicates a DMRS processing capability of the network entity, and wherein the set of DMRS parameters are in accordance with the DMRS processing capability.

12. The network entity of claim 9, wherein the capability report indicates a threshold transport block size capability associated with the network entity, and wherein the quantity of DMRS instances is based on the threshold transport block size capability.

13. The network entity of claim 1, wherein, to receive the scheduling information, the processing system is configured to:
receive a control message that indicates one or more rows in a time domain resource allocation (TDRA) table, wherein the one or more rows in the TDRA table indicate the starting slot, the starting symbol, and the quantity of DMRS instances.

14. The network entity of claim 1, wherein the indication of the set of DMRS parameters is received via a radio resource control (RRC) message, and wherein the scheduling information is received via a downlink control information (DCI) message.

15. A method of wireless communication performed by a network entity, comprising:
receiving an indication of a set of demodulation reference signal (DMRS) parameters, wherein the set of DMRS parameters is indicative of one or more DMRS offsets and a DMRS spacing;
receiving scheduling information for a shared channel communication, wherein the scheduling information indicates a starting slot for the shared channel communication, a starting symbol within the starting slot for the shared channel communication, and a quantity of DMRS instances for the shared channel communication, wherein a time domain length of the shared channel communication is based on the one or more DMRS offsets, the DMRS spacing, and the quantity of DMRS instances; and
performing the shared channel communication in accordance with the scheduling information.

16. The method of claim 15, wherein a first DMRS offset of the one or more DMRS offsets is from a first data symbol, in time, of one or more data symbols of the shared channel communication and a first DMRS symbol, in time, of the quantity of DMRS instances of the shared channel communication, a second DMRS offset of the one or more DMRS offsets is from a last data symbol, in time, of the one or more data symbols and a last DMRS symbol, in time, of the quantity of DMRS instances, and the DMRS spacing includes a quantity of symbols between adjacent DMRS instances, in time, of the quantity of DMRS instances.

17. The method of claim 15, wherein:
the set of DMRS parameters further includes a DMRS threshold parameter, the DMRS threshold parameter indicative of a threshold quantity of DMRS symbols per DMRS instance of the quantity of DMRS instances, and
the time domain length of the shared channel communication is based on the threshold quantity of DMRS symbols per DMRS instance.

18. A non-transitory computer-readable medium having code for wireless communication stored thereon that, when executed by a network entity, causes the network entity to:
receive an indication of a set of demodulation reference signal (DMRS) parameters, wherein the set of DMRS parameters is indicative of one or more DMRS offsets and a DMRS spacing;
receive scheduling information for a shared channel communication, wherein the scheduling information indicates a starting slot for the shared channel communication, a starting symbol within the starting slot for the shared channel communication, and a quantity of DMRS instances for the shared channel communication, wherein a time domain length of the shared channel communication is based on the one or more DMRS offsets, the DMRS spacing, and the quantity of DMRS instances; and
perform the shared channel communication in accordance with the scheduling information.

19. The non-transitory computer-readable medium of claim 18, wherein:
at least one of the set of DMRS parameters or the scheduling information is based on a connectivity state of the network entity,
the connectivity state is associated a set of allowed shared channel communication time domain lengths, and
the set of allowed shared channel communication time domain lengths includes the time domain length of the shared channel communication.

20. The non-transitory computer-readable medium of claim 19, wherein the connectivity state includes one of an initial access state with respect to a second network entity, a radio resource control inactive state with respect to the second network entity, a radio resource control idle state with respect to the second network entity, a radio resource control connected state prior to capability reporting, or a radio resource control connected state after receipt of a configuration message.
